(19) United States
(12) Patent Application Publication
(10) Pub. No.: US 2024/0092983 A1
(43) Pub. Date: Mar. 21, 2024

(54) CARBON NANOSTRUCTURE ENHANCED RECYCLED POLYMER MATERIAL

(71) Applicant: Ford Global Technologies, LLC, Dearborn, MI (US)

(72) Inventors: Deborah Frances Mielewski, Ann Arbor, MI (US); Paul Kenneth Dellock, Northville, MI (US); Mohan Kamath, West Bloomfield, MI (US); Stuart C. Salter, White Lake, MI (US); Alper Kiziltas, Sarikamis (TR)

(73) Assignee: Ford Global Technologies, LLC, Dearborn, MI (US)

(21) Appl. No.: 17/948,874

(22) Filed: Sep. 20, 2022

(51) Int. Cl. C08J 5/00; C08K 3/04; C08K 7/28

(52) U.S. Cl. CPC C08J 5/005; C08K 3/04; C08K 7/28; B82Y 30/00; C08J 2323/12; C08K 2201/011

(57) ABSTRACT

A composite material includes a recycled polymer matrix, a continuous network of linked carbon nanostructures dispersed within the recycled polymer matrix, and a compatibilizer. The recycled polymer matrix is in an amount of at least 90 wt. %. The continuous network of linked carbon nanostructures is in an amount between 0.5 wt. % to 1.0 wt. %. The compatibilizer is in an amount of about 3.0 wt. %.

### FIELD

The present disclosure relates to molded parts made from polymeric/plastic materials and more specifically to molded parts for automotive applications using recycled polymeric materials.

### BACKGROUND

The statements in this section merely provide background information related to the present disclosure and may not constitute prior art.

Conventional materials, such as acrylonitrile styrene acrylate (ASA) and polymers including mineral fillers, have been used to produce molded parts such as grills, appliques, badges, spoilers, bumper cover brackets, and trim pieces for vehicles. ASA, however, is in limited supply and is cost prohibitive for use in large-volume production. Parts made from ASA are also relatively heavy, which is undesirable particularly in automotive applications. Similarly, polymers having mineral fillers such as talc, calcium carbonate, mica, and wollastonite include about 20 wt. % filler which leads to increased weight and material. Parts made from polymers having mineral fillers also exhibit surface defects such as poor knit lines (i.e., where two resin flows meet) and sink marks due to inconsistent shrinkage. While not as severe as parts made from polymers having mineral fillers, parts made from ASA also exhibit sink marks on the surface of the part.

The present disclosure addresses these and other issues related to molded polymeric materials in automotive applications.

### SUMMARY

This section provides a general summary of the disclosure and is not a comprehensive disclosure of its full scope or all of its features.

According to one form of the present disclosure, a composite material comprises a recycled polymer matrix in an amount of at least 90 wt. %, a continuous network of linked carbon nanostructures dispersed within the recycled polymer matrix in an amount between 0.5 wt. % to 1.0 wt. %, and a compatibilizer in an amount of about 3.0 wt. %.

In variations of this form, which may be implemented individually or in any combination: the composite material further comprises an advanced nucleator in an amount between about 4.0 wt. % and 8.0 wt. %, an antioxidant in an amount of about 0.25 wt. %, a flow enhancer in an amount of about 1.1 wt. %, glass bubbles in an amount of about 4.0 wt. %, or at least one additive selected from the group consisting of a color concentrate, a flame retardant, and a UV light stabilizer; the recycled polymer matrix is a polypropylene material; the composite material has a maximum shrink flow of about 0.6; the composite material has a maximum shrink cross flow of about 0.6; and a part comprises the composite material.

According to another form of the present disclosure, a composite material comprises a recycled polymer matrix, a continuous network of linked carbon nanostructures dispersed within the recycled polymer matrix in an amount between 0.5 wt. % to 1.0 wt. %, a compatibilizer, and an advanced nucleator.

In variations of this form, which may be implemented individually or in any combination: the recycled polymer matrix is a polypropylene material; and the composite material further comprises an antioxidant, a flow enhancer, or at least one additive selected from the group consisting of a color concentrate, a flame retardant, and a UV light stabilizer.

According to yet another form of the present disclosure, a composite material comprises a recycled polypropylene matrix in an amount of at least 90 wt. %, a continuous network of linked carbon nanostructures dispersed within the recycled polymer matrix in an amount between 0.5 wt. % to 1.0 wt. %, a compatibilizer in an amount of about 3.0 wt. %, an advanced nucleator in an amount between about 4.0 wt. % and 8.0 wt. %, an antioxidant in an amount of about 0.25 wt. %, and a flow enhancer in an amount of about 1.1 wt. %.

In variations of this form, which may be implemented individually or in any combination: the composite material further comprises at least one additive selected from the group consisting of a color concentrate, a flame retardant, and a UV light stabilizer; the composite material has a maximum shrink flow of about 0.6; the composite material has a maximum shrink cross flow of about 0.6; and a part comprises the composite material.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a schematic view of a composite material according to the teachings of the present disclosure;

FIG. 2 illustrates an image of a continuous network of linked carbon nanostructures implemented in the composite material according to the present disclosure;

FIG. 3 illustrates an enlarged image of the continuous network of linked carbon nanostructures dispersed within a recycled polymer matrix according to the present disclosure;

FIG. 4 illustrates an enlarged image of a knit line of a polypropylene matrix with 20 wt. % talc filler according to the prior art;

FIG. 5 illustrates an enlarged image of a knit line of ASA plastic according to the prior art; and

FIG. 6 illustrates an enlarged image of a knit line of a composite material having a continuous network of linked carbon nanostructures dispersed within a recycled polymer matrix according to the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

The present disclosure provides a composite material with reduced weight and desirable creep and molding properties, and more specifically, lower shrink rates and improved appearance at knit lines. The innovative composite material may be used to make parts such as, for example, grills, appliques, badges, spoilers, bumper cover brackets, and trim pieces for vehicles. However, it should be understood that the composite material of the present application is not limited to just these applications. Additionally, the composite material of the present application is economically feasible for use in the high-volume production of parts made from the composite material.

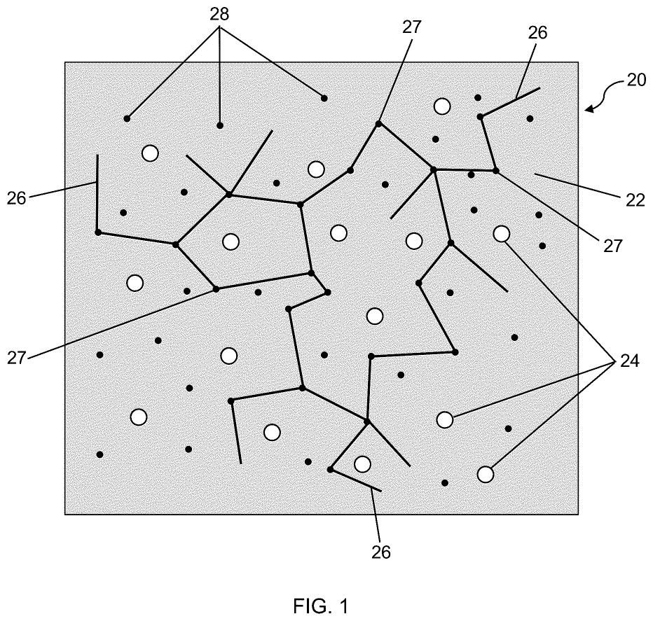

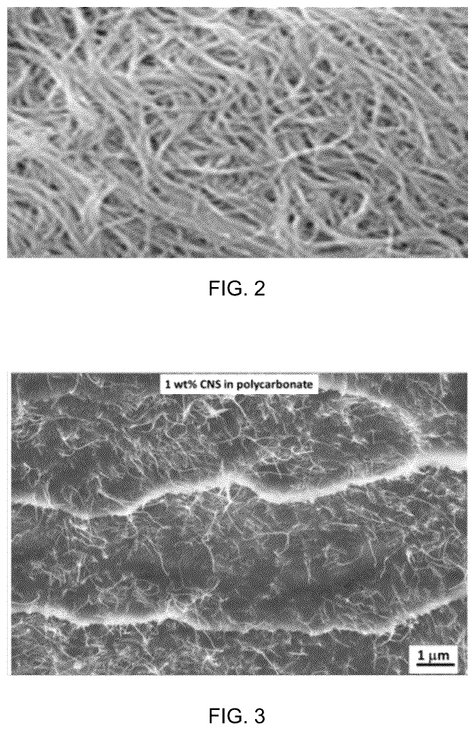

Referring to FIG. 1, a composite material according to the teachings of the present disclosure is illustrated and generally indicated by reference numeral 20. The composite material 20 comprises a recycled polymer matrix 22 such as a polypropylene material. One such example of the recycled polymer matrix 22 is recycled carpet fibers. The recycled polymer matrix 22 in one form is in an amount of at least 90 wt. %. A continuous network of linked carbon nanostructures 26 is dispersed within the recycled polymer matrix 22, as is also shown in FIGS. 2 and 3. As used herein, the continuous network of linked carbon nanostructures 26 refers to a crosslinked network of nanostructures connected by a plurality of nodes 27, which together form a structural pathway through the composite material 20. In one form of the present disclosure, the continuous network of linked carbon nanostructures 26 is in an amount between 0.5 wt. % to 1.0 wt. %. With this relatively small amount of carbon nanostructures, and because the carbon nanostructures are significantly thinner than a wavelength of light, both knit line strength and appearance is significantly improved compared with traditional mineral filled polymers. Thus, the continuous network of linked carbon nanostructures 26 stabilize the composite material 20, reduce shrink, and provide improved stiffness.

A compatibilizer is used to increase bond strength between the recycled polymer matrix 22 and the continuous network of linked carbon nanostructures 26. By way of non-limiting example, the compatibilizer may be a maleic anhydride based compatibilizer or maleic anhydride grafted polypropylene (MAPP). In one form of the present disclosure, the compatibilizer is in an amount of about 3.0 wt. %.

At least one further additive 28 may be included with the composite material 20 provide desired properties of the composite material 20. These further additives 28 may include, for example, an advanced nucleator, an antioxidant, a flow enhancer, glass bubbles, and an additive such as a color concentrate, a flame retardant, or a UV light stabilizer, among others.

Advanced nucleators increase the crystallization speed by raising the temperature and speed at which a material crystallizes by providing multiple sites for nucleation. With the increased temperature of crystallization, “freezing” of the polymer occurs at a higher temperature and the cooling time is accelerated. As a result of the faster crystallization, the composite material exhibits less shrinkage and sink marks. The composite material, having more consistent crystallinity, will also exhibit improved thermal stability, heat deflection, and flexural modulus. In one form of the present disclosure, the advanced nucleator is in an amount between about 4.0 wt. % and 8.0 wt. %. In one form of the present disclosure, the advanced nucleator has a tape-like shape. The tape-like shape of the nucleator molecules help stabilize and reduce shrink, in both the direction of the resin front flow and cross-flow, providing further reduced shrinkage and advantageously more isotropic or uniform shrink properties. Thus, the advanced nucleator further reduces shrinkage and sink marks of the composite material 20.

The composite material 20 of the present disclosure may also comprise an antioxidant. The antioxidant is added to reduce oxidation during processing and provides desired heat stability and oxidation resistance. In one form of the present disclosure, the antioxidant is in an amount of about 0.2 wt. % to about 2.0 wt. %, and more particularly in an amount of about 0.25 wt. %.

A flow enhancer may be used to adjust the melt flow rate of the composite material 20 of the present disclosure. Use of a flow enhancer further enables the polymer matrix to be completely, or 100%, recycled material. The flow enhancer is a blend of fatty acid derivatives that breaks down the polymer chain of the polymer matrix. The flow enhancer may also act as a mold release agent.

Only a small amount of flow enhancer, for example between 0.1 wt. % and 1.3 wt. %, and more particularly about 1.1 wt. %, will provide desired melt flow and impact strength of the composite material 20. By way of example, a control sample of polymer matrix without any flow enhancer exhibited a Gardner Impact value of about 8 in-lb. In comparison, samples of polymer matrix with 0.4 wt. % flow enhancer and 0.8 wt. % flow enhancer exhibited significantly increased Gardner Impact values of 64 in-lb and 40 in-lb, respectively.

In order to reduce the density of the composite material 20 for certain applications, glass bubbles 24, in the shape of hollow glass spheres for example, may be added. The glass bubbles 24 further contribute to the reduced shrinkage of the composite material 20. The density of the glass bubbles 24 are about ½ that of the polymer matrix 22 and, therefore, as more glass bubbles 24 are added, the lighter the weight of the composite material 20. In addition, while the cost of the glass bubbles is higher than that of conventional mineral fillers, this increased price is offset by the reduced amount of glass bubbles added to the composite material. According to one form of the present disclosure, about 4.0 wt. % glass bubbles are added to the composite material.

Further additives such as a color concentrate, a flame retardant, and a UV light stabilizer are also optionally added to the composite material of the present disclosure. Carbon black is one such example of a color concentrate, however any commercially available color concentrate which is compatible with the polymer matrix can be used. The flame retardant may be at least one of a brominated or chlorinated halogen flame retardant, a phosphorous based flame retardant, or a metal oxide based flame retardant.

A UV light stabilizer is used for certain applications where parts made from the composite material will be subjected to sunlight. By way of non-limiting example, the UV light stabilizer may be a hindered amine light stabilizer, or UV absorbers such as benzophenones or benzotriazoles. It is desirable that the UV light stabilizer has little to no interaction with the other additives.

### Test Data

Samples of composite material according to the present disclosure were prepared and the material properties thereof were compared against a sample of conventional composite material (Comparative Sample). This comparison is shown in Table 1 below. (For clarity, the “Test Sample” compositions are the inventive compositions according to the present disclosure)

TABLE 1
Comparison of Inventive Compositions with Sample Composition

| | Test Sample | | Test Sample | | Test Sample | | Test Sample | | Comparative | |
|---|---|---|---|---|---|---|---|---|---|---|
| | 1 (wt. %) | | 2 (wt. %) | | 3 (wt. %) | | 4 (wt. %) | | Sample | |
| Constituent | | | | | | | | | | |
| Recycled | 91.25 | | 90.75 | | 87.25 | | 100 | | — | |
| Polymer Matrix | | | | | | | | | | |
| Advanced | 4 | | 4 | | 8 | | | | — | |
| nucleator | | | | | | | | | | |
| Carbon | 0.5 | | 1 | | 0.5 | | | | — | |
| nanostructure | | | | | | | | | | |
| Compatibilizer | 3 | | 3 | | 3 | | | | — | |
| Antioxidant | 0.25 | | 0.25 | | 0.25 | | | | — | |
| Color concentrate | 1 | | 1 | | 1 | | | | — | |
| Flow enhancer | 1.1 | | 1.1 | | 1.1 | | | | — | |
| Glass bubbles | 0 | | 0 | | 4 | | | | — | |
| ASA plastic | | | | | | | | | 100 | |
| Properties | | | | | | | | | | |
| Tensile at yield | 41 | MPa | 44 | MPa | 40 | MPa | 36 | MPa | 42 | MPa |
| Tensile at break | | | | | | | | | | |
| Yield elongation | 4.7% | | 4.4% | | 4.3% | | 8.3% | | 2% | |
| Tensile modulus | | | | | | | | | | |
| Flex modulus | 2.1 | GPa | 2.2 | GPa | 2.1 | GPa | 1.7 | GPa | 2 | GPa |
| Charpy (23° C.) | 5.5 | Kj/M² | 5.9 | Kj/M² | 4.8 | Kj/M² | 3.3 | Kj/M² | 7 | Kj/M² |
| Charpy (−40° C.) | 1.4 | Kj/M² | 1.5 | Kj/M² | 1.3 | Kj/M² | 1.2 | Kj/M² | 1.5 | Kj/M² |
| Heat deformation | 78° | C. | 87° | C. | 83° | C. | 55° | C. | 80° | C. |
| temp (1.8 Mpa) | | | | | | | | | | |
| Melt flow | 32 | | 28 | | 29 | | 2 | | 15 | |
| Shrink flow | 0.58 | | 0.51 | | 0.51 | | 1.4 | | 0.52 | |
| Shrink cross flow | 0.6 | | 0.53 | | 0.53 | | 1.6 | | 0.52 | |
| Density | 0.92 | g/cc | 0.92 | g/cc | 0.88 | g/cc | 0.9 | g/cc | 1.06 | g/cc |

As can be seen from Table 1, the test samples of composite material according to the present disclosure exhibited similar properties as the comparative sample in certain categories. However, the yield elongation and melt flow of the test samples are higher than that of the comparative sample. Furthermore, the amount of filler (i.e., carbon nanostructure) in the present disclosure is about 1 wt. % or less whereas the comparative sample comprises about 20 wt. % of the mineral filler. The test samples also exhibited approximately 15% weight reduction as compared to the comparative sample.

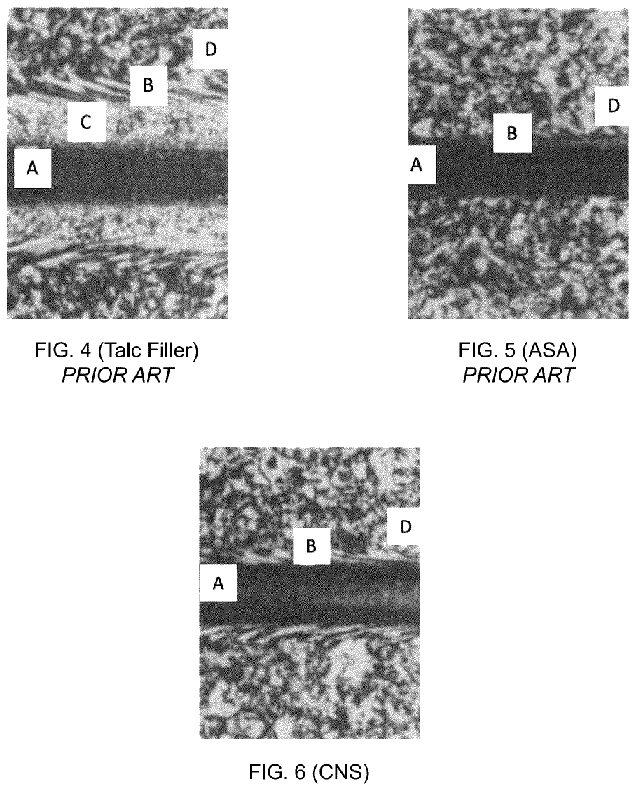

Referring now to FIGS. 4-6, a knit line of the inventive composite material of the present disclosure is compared with prior art compositions. More specifically, FIG. 4 illustrates a knit line of a polymer matrix with 20 wt. % talc filler, FIG. 5 illustrates ASA plastic (no reinforcements), and FIG. 6 illustrates the composite material according to the present disclosure with the continuous network of linked carbon nanostructures (CNS). In these figures, A corresponds to the knit line, B corresponds to additives and fillers, C corresponds to the talc filler, and D corresponds to the homogeneous composite mixture. As shown, the ASA and CNS knit lines are thinner than talc filled polypropylene, as the talc is migrated to the knit line, thereby accentuating the surface imperfection.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A composite material comprising:
a recycled polymer matrix in an amount of at least 90 wt. %;
a continuous network of linked carbon nanostructures dispersed within the recycled polymer matrix in an amount between 0.5 wt. % to 1.0 wt. %; and
a compatibilizer in an amount of about 3.0 wt. %.

2. The composite material according to claim 1, further comprising an advanced nucleator in an amount between about 4.0 wt. % and 8.0 wt. %.

3. The composite material according to claim 1, wherein the recycled polymer matrix is a polypropylene material.

4. The composite material according to claim 1, further comprising an antioxidant in an amount of about 0.25 wt. %.

5. The composite material according to claim 1, further comprising a flow enhancer in an amount of about 1.1 wt. %.

6. The composite material according to claim 1, further comprising glass bubbles in an amount of about 4.0 wt. %.

7. The composite material according to claim 1, further comprising at least one additive selected from the group consisting of a color concentrate, a flame retardant, and a UV light stabilizer.

8. The composite material according to claim 1, wherein the composite material has a maximum shrink flow of about 0.6.

9. The composite material according to claim 1, wherein the composite material has a maximum shrink cross flow of about 0.6.

10. A part comprising the composite material according to claim 1.

11. A composite material comprising:
a recycled polymer matrix;
a continuous network of linked carbon nanostructures dispersed within the recycled polymer matrix in an amount between 0.5 wt. % to 1.0 wt. %;
a compatibilizer; and
an advanced nucleator.

12. The composite material according to claim 11, wherein the recycled polymer matrix is a polypropylene material.

13. The composite material according to claim 11, further comprising an antioxidant.

14. The composite material according to claim 11, further comprising a flow enhancer.

15. The composite material according to claim 11, further comprising at least one additive selected from the group consisting of a color concentrate, a flame retardant, and a UV light stabilizer.

16. A composite material comprising:
a recycled polypropylene matrix in an amount of at least 90 wt. %;
a continuous network of linked carbon nanostructures dispersed within the recycled polymer matrix in an amount between 0.5 wt. % to 1.0 wt. %;
a compatibilizer in an amount of about 3.0 wt. %;
an advanced nucleator in an amount between about 4.0 wt. % and 8.0 wt. %;
an antioxidant in an amount of about 0.25 wt. %; and
a flow enhancer in an amount of about 1.1 wt. %.

17. The composite material according to claim 16, further comprising at least one additive selected from the group consisting of a color concentrate, a flame retardant, and a UV light stabilizer.

18. The composite material according to claim 11, wherein the composite material has a maximum shrink flow of about 0.6.

19. The composite material according to claim 11, wherein the composite material has a maximum shrink cross flow of about 0.6.

20. A part comprising the composite material according to claim 11.
